(19) United States
(12) Patent Application Publication
(10) Pub. No.: US 2003/0123566 A1
(43) Pub. Date: Jul. 3, 2003

(54) Transmitter having a sigma-delta modulator with a non-uniform polar quantizer and methods thereof

(76) Inventor: Jaime Hasson, Ganei Tikva (IL)

Correspondence Address: Eitan, Pearl, Latzer & Cohen-Zedek, 10 ROCKEFELLER PLAZA, SUITE 1001, NEW YORK, NY, 10020, US

(21) Appl. No.: 10/026,662

(22) Filed: Dec. 27, 2001

(51) Int. Cl. H04L 27/10

(52) U.S. Cl. 375/279

(57) ABSTRACT

In some embodiments of the present invention, a transmitter includes a switching amplifier and a sigma-delta N-PSK modulator. The sigma-delta N-PSK modulator includes a non-uniform polar quantizer.

### BACKGROUND OF THE INVENTION

A class E power amplifier generally achieves a significantly higher efficiency than that of a conventional class B or C power amplifier. Since a class E power amplifier operates as an on/off switch, a constant envelope driver signal is desired. However, in certain cellular communication standards, for example Enhanced General Packet Radio Service (EGPRS) and Wideband Code Division Multiple Access (WCDMA), the baseband modulating signal typically includes amplitude variations.

An oversampled sigma-delta quadrature phase shift keying (QPSK) modulator may be used to generate a constant envelope signal from any amplitude-varying signal. Therefore, a radio having a class E power amplifier may use such a modulator to generate a constant envelope driver signal for the class E power amplifier from the amplitude-varying baseband modulating signal. Since the modulator may increase noise at frequencies far from the carrier, a bandpass filter may be located between the output of the class E power amplifier and a radio frequency antenna.

The driver signal may be a digital clock at a radio frequency with four possible phase transitions: 0°; 90°; −90°; 180°. The bandpass filter may store energy at the previous phase. However, when a phase transition occurs in the driver signal, some of the energy stored by the bandpass filter may be lost. The larger the phase transition, the more energy may be lost by the bandpass filter.

In practice, for QPSK, the collector efficiency may drop to 60% for a bandwidth of half the sampling frequency of the sigma-delta QPSK modulator and to 40% for a bandwidth of a quarter of the sampling frequency. Typically a bandwidth of less than a quarter of the sampling frequency is needed to attenuate the noise, so the efficiency of a radio having a class E power amplifier, a sigma-delta QPSK modulator and a bandpass filter may be worse than that of a radio having a classical AB power amplifier.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block diagram of a transmitter according to an embodiment of the present invention;

FIG. 2 is a simplified block diagram of a sigma-delta N-phase shift keying (PSK) modulator, according to some embodiments of the present invention;

FIG. 3 is an illustration of a non-uniform polar quantizer for quadrature phase shift keying (QPSK), according to some embodiments of the present invention;

FIG. 4 is an illustration of a non-uniform polar quantizer for 8-PSK, according to some embodiments of the present invention; and

FIGS. 5 and 6 are graphical illustrations of the output spectral density of a first order sigma-delta QPSK modulator having a uniform quantizer and an exemplary non-uniform quantizer, respectively.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures and components have not been described in detail so as not to obscure the present invention.

It should be understood that the present invention may be used in a variety of applications, including, but not limited to, a mobile communication device. Although the present invention is not limited in this respect, the circuit disclosed herein may be used in many apparatuses such as in the transmitters of a radio system. Radio systems intended to be included within the scope of the present invention include, by way of example only, cellular radiotelephone communication systems, two-way radio communication systems, one-way pagers, two-way pagers, digital system transmitters, analog system transmitters, personal communication systems (PCS), and the like.

Types of cellular radiotelephone communication systems intended to be within the scope of the present invention include, although are not limited to, Direct Sequence—Code Division Multiple Access (DS-CDMA) cellular radiotelephone communication systems, Wideband CDMA (WBCDMA) and CDMA2000 cellular radiotelephone systems, General Packet Radio Service (GPRS) cellular radiotelephone systems, Enhanced General Packet Radio Service (EGPRS) cellular radiotelephone systems, Personal Digital Cellular (PDC) cellular radiotelephone communication systems, Global System for Mobile Communications (GSM) cellular radiotelephone systems, North American Digital Cellular (NADC) cellular radiotelephone systems, Time Division Multiple Access (TDMA) systems, Enhanced Data for GSM Evolution (EDGE) and Universal Mobile Telecommunications Systems (UMTS).

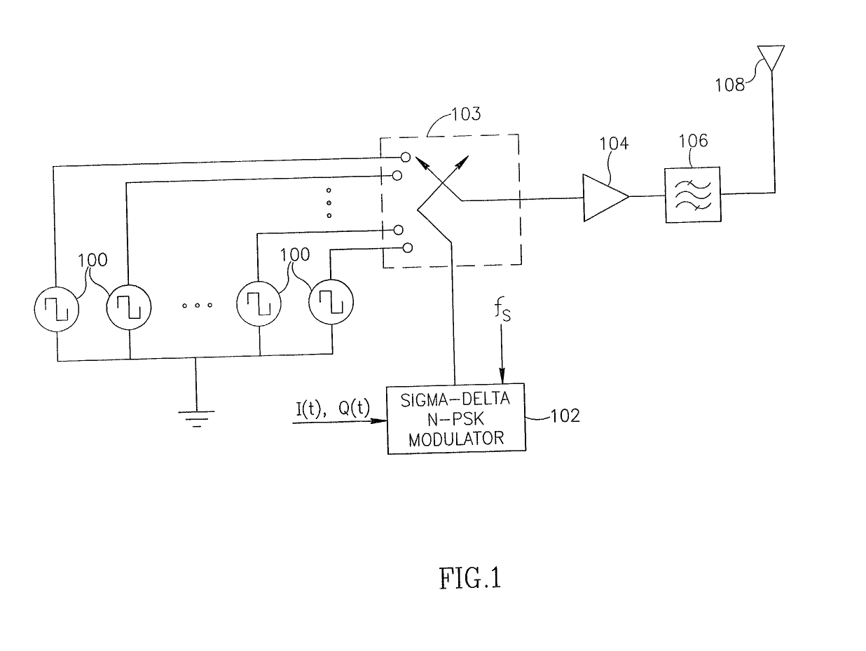

FIG. 1 is a block diagram of a transmitter according to an embodiment of the present invention, The transmitter may be part of a mobile communication device, although the scope of the present invention is not limited in this respect. A transmitter may comprise N oscillators 100 able to produce N carrier signals having the same frequency and different phases, where N is typically 2, 4, 8, 16 or 32, a sigma-delta N-phase shift keying (N-PSK) modulator 102, a preamplifier and a switching amplifier 104, a bandpass filter 106 coupled to switching amplifier 104, and an antenna 108 coupled to bandpass filter 106. Alternatively, although not shown in FIG. 1, the transmitter may comprise, instead of the N oscillators 100, one oscillator and (N−1) phase shifters, or any appropriate combination of oscillators and phase shifters, so as to produce N carrier signals having the same frequency and different phases. Although the scope of the present invention is not limited in this respect, the frequency of the N carrier signals may be a radio frequency.

Switching amplifier 104 may comprise a class-E power amplifier, although the scope of the present invention is not limited in this respect.

Antenna 108 may be a dipole antenna, a shot antenna, a dual antenna, an omni-directional antenna, a loop antenna or any other antenna type which may be used with mobile station transmitters, if desired, although the scope of the present invention is not limited in this respect.

Modulator 102 may receive as input a complex baseband amplitude-varying modulation signal (I(t),Q(t)). Modulator 102 may oversample the input signal at a sampling frequency fₛ, and may perform phase-quantization, thus producing a digital signal representing one of a set of N symbols.

The transmitter may also comprise a selector 103 that is able to select one of the N carrier signals based upon the digital output of modulator 102. The output of selector 103 may be a constant envelope signal at a radio frequency having a changing phase, although the scope of the present invention is not limited in this respect.

The selected carrier may be amplified by preamplifier and switching amplifier 104 and transmitted by antenna 108. Modulator 102 may reduce the noise at frequencies close to the carrier and may increase the noise at frequencies far from the carrier. Therefore bandpass filter 106 may be coupled to the output of switching amplifier 104 in order to filter out the noise at frequencies far from the carrier.

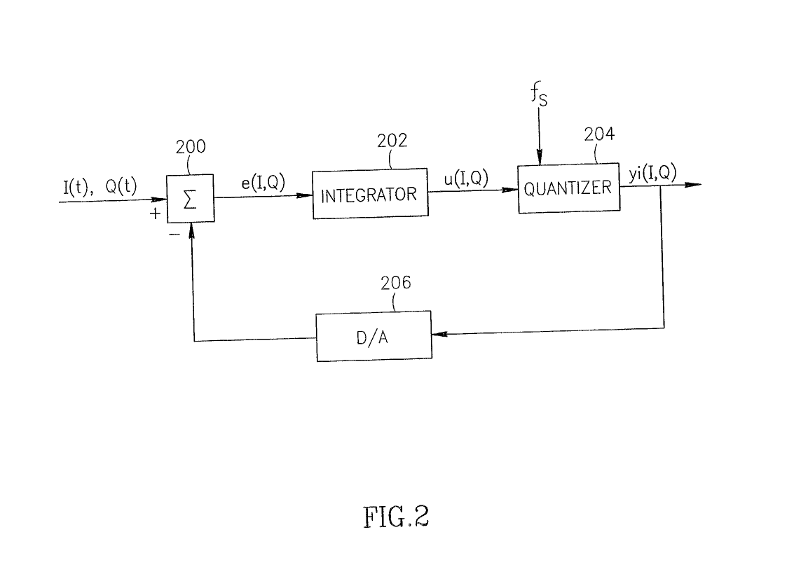

FIG. 2 is a block diagram of modulator 102, according to some embodiments of the present invention. Sigma-delta N-PSK modulator 102 may comprise an adder 200, an integrator 202, and a quantizer 204. Integrator 202 may be a first-order integrator or may be a higher-order integrator. As mentioned hereinabove with respect to FIG. 1, the input to modulator 102 may be a complex baseband amplitude-varying modulation signal (I(t),Q(t)). Modulator 102 may comprise a feedback loop so that adder 200 subtracts the output of quantizer 204 from the input signal. If the input signal is an analog signal, then the feedback loop may comprise a digital-to-analog (D/A) converter 206. Therefore, the output of adder 200 may be a difference signal e(I(t),Q(t)). Difference signal e(I(t),Q(t)) may be fed to integrator 202, which may produce an integrated signal u(I(t),Q(t)), whose values may be anywhere in the complex plane. Integrated signal u(I(t),Q(t)) may then be fed to quantizer 204, whose output may be a digital signal y₁(I(t),Q(t)) representing one of a set of symbols. Quantizer 204 may output the digital signal at sampling frequency fₛ.

According to some embodiments of the present invention, quantizer 204 may be a non-uniform polar quantizer. For N-PSK modulation, the complex plane may be partitioned into N cells, not all having the same size, and a symbol may be associated with each cell of the partition. The N non-uniform cells may completely cover the complex plane in a non-overlapping manner.

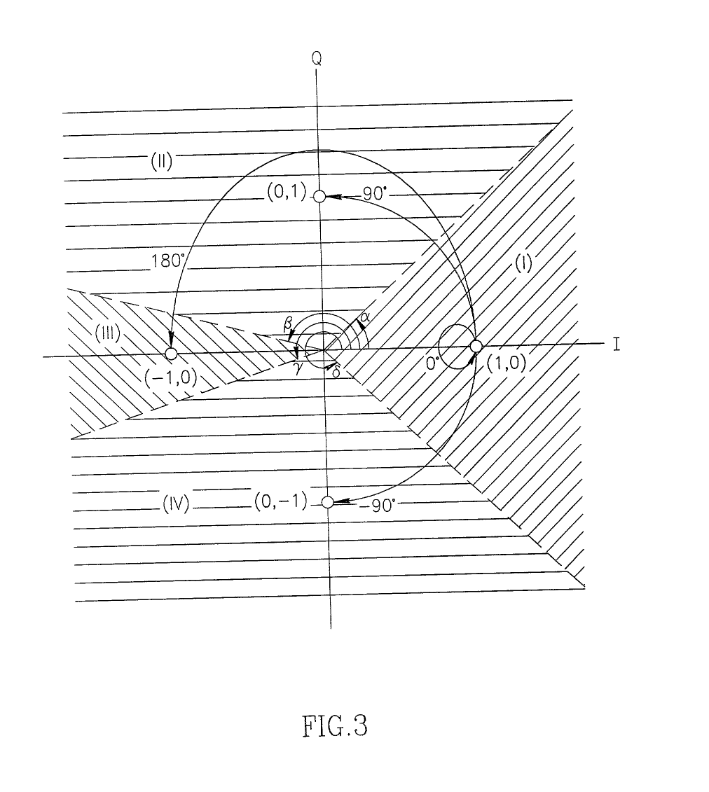

FIG. 3 is an illustration of a non-uniform polar quantizer for quadrature phase shift keying (QPSK), according to some embodiments of the present invention. The complex I-Q plane is divided into four cells, marked (I), (II), (III) and (IV), each cell having a symbol located therein. The cell boundaries, at [α°;β°,γ°,δ°], are non-symmetric, therefore the cells are not all of equal size. Quantizer 204 may output a digital signal y₁(I(t),Q(t)) representing a symbol according to the cell to which u(I(t),Q(t)) belongs. In QPSK, the set of symbols may be, for example, the set {(1,0); (0,1); (−1,0); (0,−1)}, although other sets of four symbols (one per cell) may be used instead. Since a later value of signal u(I(t),Q(t)) may belong to a different cell, phase transitions from one symbol to another may occur. The set of possible phase transitions in QPSK may be 0°, 90°, −90°, and 180°, although other sets of possible phase transitions may be used instead.

Once a phase transition has occurred, the cells may be redefined so that the cell boundaries rotate with the present state of the quantizer. The redefinition of the cell boundaries may be implemented in hardware, for example, with the use of a look-up table relating the cell boundaries to the present state, or may be implemented in software or in any combination of hardware and software. For example, if a −90° phase transition occurs from symbol (1,0) to symbol (0,−1), then the cell boundaries may be redefined as [(α−90)°;(β−90)°,(γ−90)°,(δ−90)°].

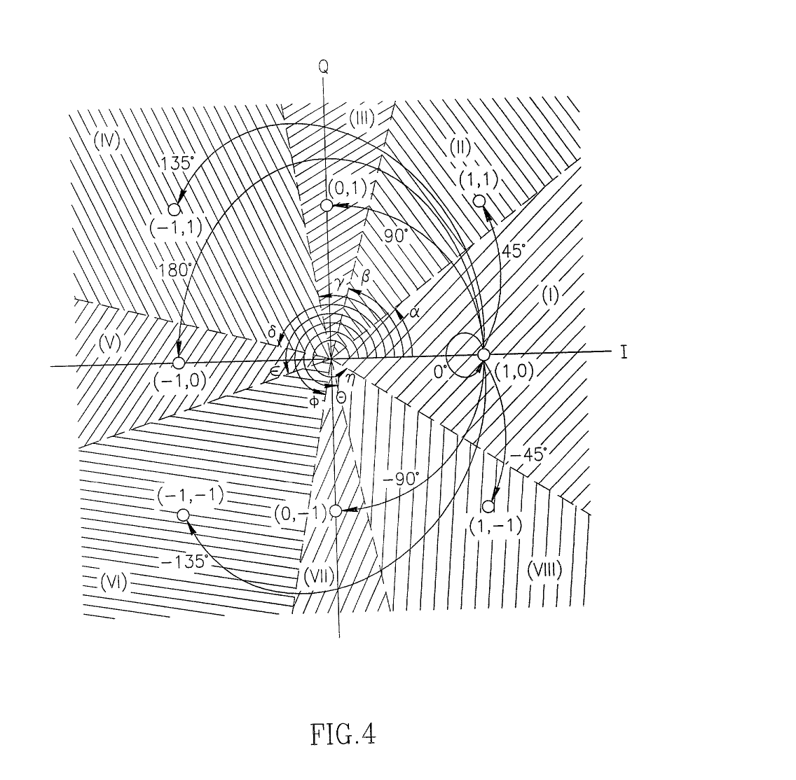

FIG. 4 is an illustration of a non-uniform polar quantizer for 8-PSK, according to some embodiments of the present invention. The complex I-Q plane is divided into eight cells, marked (I)-(VIII), each cell having a symbol located therein. The cell boundaries, at [α°;β°;γ°;δ°;ε°;φ°;θ°;η°], are non-symmetric, therefore the cells are not all of equal size. Quantizer 204 may output a digital signal y₁(I(t),Q(t)) representing a symbol according to the cell to which u(I(t),Q(t)) belongs. In 8-PSK, the set of symbols may be, for example, the set {(1,0); (1,1); (0,1); (−1,1); (−1,0); (−1,−1); (0,−1); (1,−1)}, although other sets of eight symbols (one per cell) may be used instead. Since a later value of signal u(I(t),Q(t)) may belong to a different cell, phase transitions from one symbol to another may occur. The set of possible phase transitions in 8-PSK may be 0°, 45°, −45°, 90°, −90°, 135°, −135°, and 180°, although other sets of possible phase transitions may be used instead.

Once a phase transition has occurred, the cells may be redefined so that the cell boundaries rotate with the present state of the quantizer. For example, if a −45° phase transition occurs from symbol (1,0) to symbol (1,−1), then the cell boundaries may be redefined as [(α−45)°;(β−45)°;(γ−45)°;(δ−45)°;(ε−45)°;(φ−45)°;(θ−45)°;(η−45)°].

The selection of non-symmetric cell boundaries may affect the statistics of phase transitions. In particular, certain non-symmetric cell boundaries may reduce the occurrence of larger phase transitions as compared to those of a uniform polar quantizer. In other words, a sigma-delta N-PSK modulator comprising a non-uniform polar quantizer may have fewer large phase transitions than a sigma-delta N-PSK modulator comprising a uniform polar quantizer. This reduction in the number of large phase transitions may lead to an increase in the collector efficiency of a transmitter comprising having a sigma-delta N-PSK modulator having such a non-uniform polar quantizer.

It will be appreciated by those of ordinary skill in the art that by increasing the number of symbols, the distribution of phase transitions may be concentrated at low phase transition values, which may further increase the collector efficiency of a transmitter comprising a sigma-delta N-PSK modulator having such a non-uniform polar quantizer.

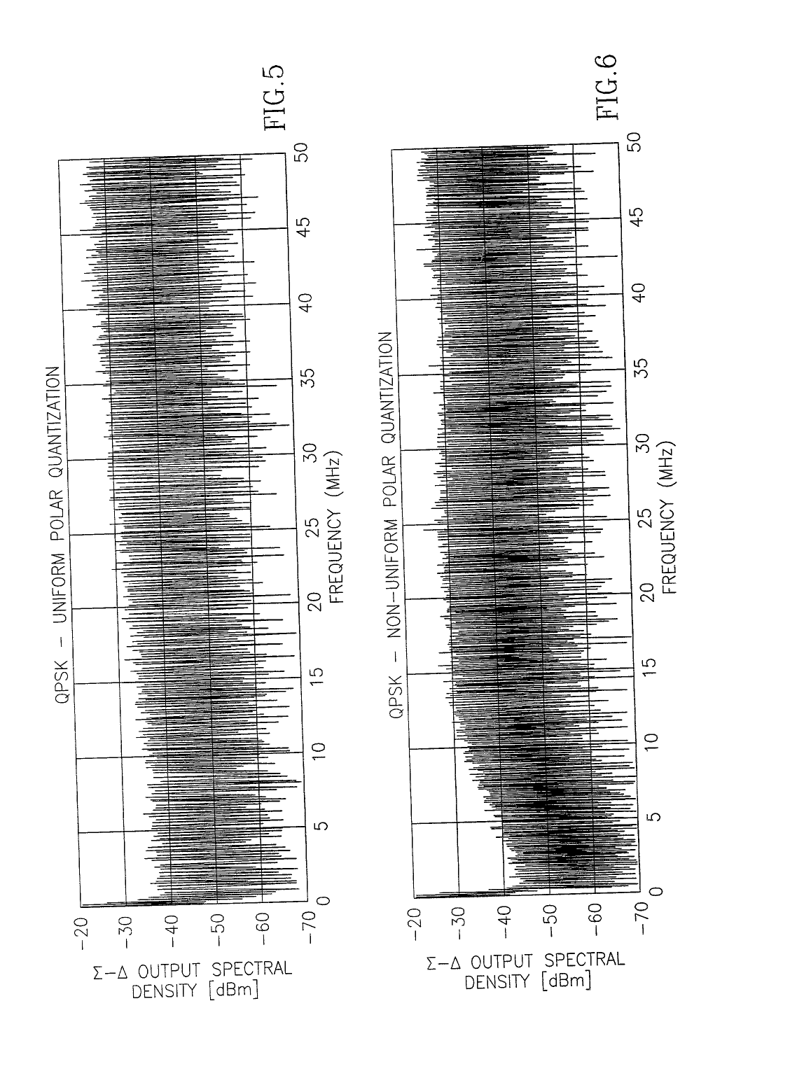

The selection of the non-symmetric cell boundaries may also affect the noise shaping spectrum of a sigma-delta N-PSK modulator having a non-uniform polar quantizer. FIGS. 5 and 6 show the output spectral density of a first order sigma-delta QPSK modulator having a uniform quantizer and an exemplary non-uniform quantizer, respectively. The exemplary non-uniform polar quantizer has cell boundaries at [±45°;±177°]. It will be appreciated by those of ordinary skill in the art that the use of certain non-symmetrical cell boundaries may reduce the noise at low frequencies while increasing it at higher frequencies.

Since higher frequencies may be simpler to filter than lower frequencies, using known techniques, there may be several transmission applications where it may be desirable to use a sigma-delta modulator comprising a non-uniform polar quantizer in accordance with embodiments of the present invention. These applications may include mobile telephones, digital audio and asynchronous digital subscriber line (ADSL).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A portable communication device comprising:
a sigma-delta N-phase shift keying modulator having a non-uniform polar quantizer.

2. The portable communication device of claim 1 wherein said N is selected from a group including: 2, 4, 8, 16 and 32.

3. A portable communication device comprising:
a sigma-delta N-phase shift keying modulator able to convert a baseband input signal into a quantized output signal, the modulator comprising:
an adder able to subtract said quantized output signal from said baseband input signal to produce a difference signal;
an integrator able to integrate said difference signal to produce an integrated signal; and
a non-uniform polar quantizer able to produce said quantized output so that it represents a symbol selected from a set of N symbols according to which of a set of N non-uniform cells the phase of said integrated signal belongs, said N non-uniform cells completely covering the complex plane in a non-overlapping manner.

4. The portable communication device of claim 3, wherein said N is selected from a group including: 2, 4, 8, 16 and 32.

5. A transmitter comprising:
a dipole antenna;
a sigma-delta N-phase shift keying modulator coupled to said dipole antenna, said modulator comprising:
a non-uniform polar quantizer.

6. The transmitter of claim 5 further comprising:
a switching amplifier coupled to said modulator and to said dipole antenna.

7. The transmitter of claim 6, wherein said switching amplifier comprises a class-E power amplifier.

8. The transmitter of claim 6 further comprising:
a bandpass filter coupled to output of said switching amplifier and coupled to said dipole antenna.

9. The transmitter of claim 5, wherein said N is selected from a group including: 2, 4, 8, 16 and 32.

10. A mobile telephone comprising:
a dipole antenna; and
a sigma-delta N-phase shift keying modulator coupled to said dipole antenna, said modulator comprising:
a non-uniform polar quantizer.

11. The mobile telephone of claim 10 further comprising:
a switching amplifier coupled to said modulator and to said dipole antenna.

12. The mobile telephone of claim 11, wherein said switching amplifier comprises a class-E power amplifier.

13. The mobile telephone of claim 11 further comprising:
a bandpass filter coupled to output of said switching amplifier and coupled to said dipole antenna.

14. The mobile telephone of claim 10, wherein said N is selected from a group including: 2, 4, 8, 16 and 32.

15. A method comprising:
subtracting a quantized output signal from a baseband input signal to produce a difference signal;
integrating said difference signal to produce an integrated signal; and
producing said quantized output by selecting a symbol from a set of N symbols according to which of a set of N non-uniform cells the phase of said integrated signal belongs, said N non-uniform cells completely covering the complex plane in a non-overlapping manner.

16. The method of claim 15, wherein said baseband input signal is analog and further comprising:
converting said quantized output signal from digital to analog prior to subtracting said quantized output signal from said baseband input signal.

17. The method of claim 15, wherein said N is selected from a group including: 2, 4, 8, 16 and 32.

18. The method of claim 15, further comprising:
using said quantized output signal to select one of N carrier signals each having a frequency and a different one of N phases, thus producing a constant envelope signal at said frequency having variable phase; and
amplifying, filtering and transmitting said constant envelope signal.

19. The method of claim 18, wherein said frequency is a radio frequency.
